(19) United States
(12) Patent Application Publication
(10) Pub. No.: US 2026/0337723 A1
(43) Pub. Date: Oct. 29, 2026

(54) METHODS FOR SHORT-PROCESS AND HIGH-VALUE UTILIZATION OF VANADIUM-TITANIUM MAGNETITE RESOURCES

(71) Applicant: CENTRAL SOUTH UNIVERSITY, Changsha (CN)

(72) Inventors: Guanghui LI, Changsha (CN); Tao JIANG, Changsha (CN); Lingyun YI, Changsha (CN); Jun LUO, Changsha (CN); Hao JIANG, Changsha (CN); Mingjun RAO, Changsha (CN); Yanhong WANG, Changsha (CN); Dongfang LU, Changsha (CN); Guangyi LIU, Changsha (CN)

(73) Assignee: CENTRAL SOUTH UNIVERSITY, Changsha (CN)

(21) Appl. No.: 19/392,102

(22) Filed: Nov. 17, 2025

(30) Foreign Application Priority Data
Apr. 25, 2025 (CN) 202510525993.2

(51) Int. Cl. C22B 34/22; C22B 1/24; C22B 1/242; C22B 34/12

(52) U.S. Cl. CPC C22B 34/22; C22B 1/2406; C22B 1/242; C22B 34/1213; C22B 34/124; C22B 34/1295

(57) ABSTRACT

Provided is a method for short-process and high-value utilization of vanadium-titanium magnetite resources, including co-enriching a raw vanadium-titanium magnetite ore to obtain an iron-vanadium-titanium co-beneficiation concentrate; mixing the iron-vanadium-titanium co-beneficiation concentrate, a solid carbonaceous reductant, a binder, and a magnesium-based modifier to obtain a mixture, and pelletizing or briquetting the mixture to prepare carbon-containing pellets; pre-reducing the carbon-containing pellets in a hydrogen-containing atmosphere to obtain pre-reduced pellets; and smelting and separating the pre-reduced pellets to obtain molten iron and a vanadium-titanium-rich slag. By co-enriching and co-smelting ilmenite and vanadium-titanium magnetite, problems such as excessive fine grinding in conventional iron/titanium separation process, a use of toxic flotation reagents, and resource waste are avoided. By optimizing a new calcium-free slag system through MgO adjustment in the concentrate and FeO control during pre-reduction, controllable separation of iron and vanadium-titanium is achieved, thereby realizing a short-process and high-value utilization of vanadium-titanium magnetite resources.

### CROSS-REFERENCE TO RELATED APPLICATIONS

This application claims priority to the Chinese Patent Application No. 202510525993.2, filed on Apr. 25, 2025, the contents of which are hereby incorporated by reference.

### TECHNICAL FIELD

The present disclosure generally relates to the field of mineral utilization, and in particular to a method for short-process and high-value utilization of vanadium-titanium magnetite resources.

### BACKGROUND

Vanadium-titanium magnetite is a composite ore co-existing with a plurality of metallic elements, such as iron, vanadium, titanium, chromium, nickel, and cobalt. The vanadium-titanium magnetite has extremely high comprehensive utilization value and is internationally recognized as an important strategic mineral resource.

In a raw vanadium-titanium magnetite ore, two main types of minerals, titanomagnetite and ilmenite, are primarily present, which are closely intergrown with fine crystal particle sizes. However, smelting behaviors of iron-bearing and titanium-bearing minerals differ significantly. Direct smelting in a single step readily causes mutual interference, thereby affecting a metal recovery and hindering selective smelting and separation of metals. A current development and utilization process of vanadium-titanium magnetite resources mainly follow a strategy of separating the vanadium-titanium magnetite into an iron concentrate and a titanium concentrate, and then respectively smelting the iron concentrate and the titanium concentrate. The typical steps include: pre-separating an iron concentrate (containing TFe~55%, V₂O₅~0.5%, TiO₂~10%) from the raw vanadium-titanium magnetite ore through low-intensity magnetic separation, and obtaining a titanium concentrate (containing TFe~35%, V₂O₅~0.1%, TiO₂~48%) from an iron tailing through high-intensity magnetic separation. The iron concentrate is smelted in a blast furnace. The iron element is recovered in a form of molten iron for steelmaking. The vanadium element, after entering the molten iron during the smelting process, is recovered as V₂O₅ through subsequent converter vanadium-slag blowing and sodium-vanadium extraction processes. The titanium element (accounting for approximately 52% of total titanium resources) is converted into stable perovskite and enters blast furnace slag, making this portion of titanium completely unrecoverable. Concurrently, a portion of co-associated rare elements, such as nickel and cobalt, also enters the blast furnace slag and remains unutilized. The obtained titanium concentrate is used for producing titanium dioxide powder by a sulfuric acid process, and iron and vanadium elements in the titanium concentrate are not recovered. The existing process for the vanadium-titanium magnetite resources adopts a route in which iron and titanium are separately selected and separately utilized, resulting in titanium, nickel, and cobalt elements in the iron concentrate entering the blast furnace slag and being unrecoverable, a complicated vanadium extraction process with low recovery efficiency, and unrecovered iron and vanadium in the titanium concentrate. Consequently, utilization rates of iron, vanadium, and titanium are only 79%, 44%, and 29%, respectively. In addition, Chinese Patent Application (Publication No. CN115522074A) discloses a slag-forming method for electric furnace smelting of the vanadium-titanium magnetite. The slag-forming method includes: S1, performing pre-reduction on oxidized pellets of a vanadium-titanium magnetite concentrate to obtain metallized pellets of the vanadium-titanium magnetite; S2, adding the metallized pellets of the vanadium-titanium magnetite, a calcium-based slag-forming agent, and a reducing agent into an electric furnace in a certain ratio for deep reduction; S3, performing smelting after the deep reduction, and separating slag and iron to obtain vanadium-bearing molten iron and titanium-bearing molten-separated slag; and S4, performing a vanadium extraction treatment on the vanadium-bearing molten iron in a converter, and performing a titanium extraction treatment on the titanium-bearing molten-separated slag by a chemical process. This method has a complex process, and since vanadium enters the molten iron, a considerable metallurgical loss of metals occurs during the treatment process.

In summary, the existing processes for recovering metallic resources from the vanadium-titanium magnetite are relatively complex and suffer from substantial losses of valuable metallic elements during processing.

### SUMMARY

One or more embodiments of the present disclosure provide a method for short-process and high-value utilization of vanadium-titanium magnetite resources, including: (a) subjecting a raw vanadium-titanium magnetite ore to crushing, grinding, and pre-concentration by countercurrent gravity separation; subjecting a gravity separation rough concentrate obtained from the pre-concentration to reverse flotation to remove aluminum- and silicon-bearing minerals to obtain an iron-vanadium-titanium co-beneficiation concentrate enriched with ilmenite and vanadium-titanium magnetite from the raw vanadium-titanium magnetite ore; wherein the raw vanadium-titanium magnetite ore includes the ilmenite, magnetite, and titanium magnetite, and is intergrown with at least one of feldspar, olivine, pyroxene, serpentine, chlorite, and amphibole; a phase in which Fe occurs includes at least one of the magnetite, the ilmenite, fayalite, and pyrite, and a phase in which Ti occurs includes the titanium magnetite and the ilmenite; wherein a weight ratio of the iron-vanadium-titanium co-beneficiation concentrate, a solid carbonaceous reductant, and a binder is 100:(1~10):(0.5~3); (b) mixing the iron-vanadium-titanium co-beneficiation concentrate, the solid carbonaceous reductant, the binder, and a magnesium-based modifier to obtain a mixture, and pelletizing or briquetting the mixture to prepare carbon-containing pellets; subjecting the carbon-containing pellets in a hydrogen-containing atmosphere for a pre-reduction treatment to obtain pre-reduced pellets having a metallization degree of 85 to 98%, an FeO content of 1 to 15%, and an MgO content of 0.5 to 10%; and (c) smelting and separating the pre-reduced pellets to obtain molten iron and a vanadium-titanium-rich slag.

### BRIEF DESCRIPTION OF THE DRAWINGS

FIG. 1 is a flowchart illustrating an exemplary method for short-process and high-value utilization of vanadium-titanium magnetite resources according to some embodiments of the present disclosure.

FIG. 2 is a schematic diagram illustrating an X-ray diffraction (XRD) pattern of a vanadium-titanium-rich slag according to Embodiment 1 of the present disclosure.

FIG. 3 is a schematic diagram illustrating an exemplary process for vanadium-titanium magnetite according to Embodiment 7 of the present disclosure.

### DETAILED DESCRIPTION

In view of problems in the prior art, such as a long process flow for utilizing valuable metals in vanadium-titanium magnetite and a low utilization rate of valuable metals, one or more embodiments of the present disclosure aim to provide a method for short-process and high-value utilization of vanadium-titanium magnetite resources, aiming to provide a novel smelting method that is short, highly selective, and achieves high recovery rates, eliminating the need for separate iron/titanium/vanadium beneficiation and enabling the direct reduction-melting separation of iron from vanadium and titanium. The smelting method includes subjecting a raw vanadium-titanium magnetite ore to a series of treatments, ultimately obtaining molten iron and a vanadium-titanium-rich slag, from which the vanadium and titanium may be further recovered, thereby realizing a high-value and comprehensive utilization of the vanadium-titanium magnetite resources. The following descriptions are provided to further illustrate one or more embodiments of the present disclosure, rather than to limit one or more embodiments of the present disclosure.

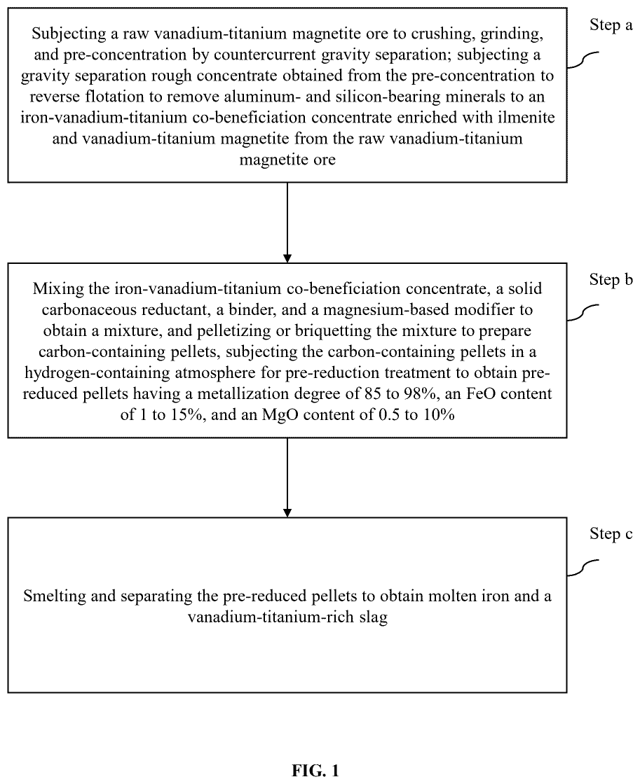

FIG. 1 is a flowchart illustrating an exemplary method for short-process and high-value utilization of vanadium-titanium magnetite resources according to some embodiments of the present disclosure.

In some embodiments, as shown in FIG. 1, the method for short-process and high-value utilization of the vanadium-titanium magnetite resources includes following step a-step c.

Step a: subjecting a raw vanadium-titanium magnetite ore to crushing, grinding, and pre-concentration by countercurrent gravity separation; subjecting a gravity separation rough concentrate obtained from the pre-concentration to reverse flotation to remove aluminum- and silicon-bearing minerals to obtain an iron-vanadium-titanium co-beneficiation concentrate enriched with ilmenite and the vanadium-titanium magnetite from the raw vanadium-titanium magnetite ore.

The raw vanadium-titanium magnetite ore (hereinafter referred to as the raw ore) is a raw ore to be processed. The raw vanadium-titanium magnetite ore includes the ilmenite (FeTiO₃), magnetite (Fe₃O₄), and titanium magnetite. The raw vanadium-titanium magnetite ore is intergrown with at least one of feldspar, olivine, pyroxene, serpentine, chlorite, and amphibole.

In the raw vanadium-titanium magnetite ore, a phase in which Fe occurs includes at least one of the magnetite, the ilmenite, fayalite, and pyrite, and a phase in which Ti occurs includes the titanium magnetite and the ilmenite.

The phase refers to a specific mineral form or chemical composition state in which a particular element exists in a mineral or material.

Furthermore, the raw vanadium-titanium magnetite ore also includes at least one valuable element selected from Ni, Co, and Sc, which may coexist with pyrite and pyrrhotite.

In one or more embodiments of the present disclosure, the raw vanadium-titanium magnetite ore contains 20 to 30 wt. % of Fe, 0.1 to 0.5 wt. % of V₂O₅, and 5 to 8 wt. % of TiO₂. In one or more embodiments of the present disclosure, the raw vanadium-titanium magnetite ore further includes 0.01 to 0.1 wt. % of Ni and 0.01 to 0.1 wt. % of Co.

After subjected to crushing and grinding, the raw vanadium-titanium magnetite ore has a particle size controlled such that a content of −0.15 mm fraction is in a range of 70 to 95%.

The countercurrent gravity separation is a mineral processing technique that separates minerals based on differences in densities of the minerals within a fluid medium. In this process, a pulp flows countercurrent to a water flow, high-density minerals settle, while low-density minerals are discharged with the water flow, thereby achieving pre-concentration. Through the countercurrent gravity separation, a portion of gangue minerals can be preliminarily removed, thus increasing a content of a target mineral.

A count of times for the countercurrent gravity separation is 1 to 3.

The pre-concentration refers to a process of increasing a grade of the target mineral through initial countercurrent gravity separation. For example, high-density Fe-, V-, and Ti-bearing minerals may be separated from the raw vanadium-titanium magnetite ore to reduce a load for subsequent processes.

The grade refers to a content of a valuable component in the ore. For example, the grade includes contents of the Fe-, V-, and Ti-bearing minerals in the raw vanadium-titanium magnetite ore.

The gravity separation rough concentrate is a product obtained after the pre-concentration via the countercurrent gravity separation. The contents of Fe, V, and Ti in the gravity separation rough concentrate are higher than those in the raw ore, but a certain amount of the gangue minerals still remains.

The reverse flotation is a flotation process based on a principle that target minerals (the Fe-, V-, and Ti-bearing minerals) are suppressed from floating in the pulp, while the gangue minerals (e.g., aluminum- and silicon-bearing minerals) are activated by a collector and attach to air bubbles to float out with froth, thereby achieving a removal of gangue. Through the reverse flotation, the gangue minerals such as aluminum- and silicon-bearing minerals can be efficiently removed from the ore, further improving the grade of Fe, V, and Ti.

In one or more embodiments of the present disclosure, tailings from the countercurrent gravity separation may be subjected to magnetic separation as needed, and minerals from the magnetic separation may be recycled to the reverse flotation process and/or a pre-reduction process.

In one or more embodiments of the present disclosure, the iron-vanadium-titanium co-beneficiation concentrate co-enriched with the ilmenite and the vanadium-titanium magnetite may be obtained through a co-enrichment process of the countercurrent gravity separation and the reverse flotation. A weight ratio of the ilmenite to the vanadium-titanium magnetite in the iron-vanadium-titanium co-beneficiation concentrate is 1:5 to 3:4.

The iron-vanadium-titanium co-beneficiation concentrate is an enriched product obtained after the reverse flotation, in which contents of the ilmenite and the vanadium-titanium magnetite are significantly increased, providing a high-quality feedstock for subsequent reduction and smelting processes.

In one or more embodiments of the present disclosure, the raw ore is subjected to simple coarse grinding and subsequent enrichment via the countercurrent gravity separation. A combination with the countercurrent gravity separation process facilitates a selective melting of iron and the vanadium-titanium in subsequent steps and helps optimize the physical and chemical activity of a resulting vanadium-titanium slag, thereby promoting a recovery of the vanadium-titanium.

A solid carbonaceous reductant refers to a solid carbon-containing substance capable of providing carbon and reducing metal oxides at high temperatures.

A binder refers to a substance capable of agglomerating powdery materials into a pellet that has a certain strength and shape.

More descriptions regarding the solid carbonaceous reductant and the binder may be found in the related descriptions below.

In some embodiments, a weight ratio of the iron-vanadium-titanium co-beneficiation concentrate to the solid carbonaceous reductant may be 100:1, 100:3, 100:5, 100:7, or 100:10. The weight ratio of the solid carbonaceous reductant to the iron-vanadium-titanium co-beneficiation concentrate may be adjusted based on factors including a target metallization degree, carbon utilization efficiency, and reduction capabilities of different solid carbonaceous reductants.

In some embodiments, a weight ratio of the iron-vanadium-titanium co-beneficiation concentrate to the binder may be 100:0.5, 100:1, 100:1.5, 100:2, 100:2.5, or 100:3. The weight ratio of the iron-vanadium-titanium co-beneficiation concentrate to the binder may be adjusted based on factors including a pelletizing or briquetting performance of a mixture and mechanical strength of the carbon-containing pellets. In some embodiments, an appropriate ratio may be selected from the above ranges based on actual conditions.

In some embodiments, a weight ratio of the iron-vanadium-titanium co-beneficiation concentrate, the solid carbonaceous reductant, and the binder used in the method is 100:(1-10):(0.5-3).

In some embodiments, the weight ratio of the iron-vanadium-titanium co-beneficiation concentrate, the solid carbonaceous reductant, and the binder used in the method is 100:(1-4):(0.5-2).

In some embodiments, the weight ratio of the iron-vanadium-titanium co-beneficiation concentrate, the solid carbonaceous reductant, and the binder used in the method is 100:(8-10):(2-3).

In some embodiments, the weight ratio of the iron-vanadium-titanium co-beneficiation concentrate, the solid carbonaceous reductant, and the binder used in the method is 100:5:2.

Step b: mixing the iron-vanadium-titanium co-beneficiation concentrate, the solid carbonaceous reductant, the binder, and a magnesium-based modifier to obtain a mixture; pelletizing or briquetting the mixture to prepare carbon-containing pellets; subjecting the carbon-containing pellets in a hydrogen-containing atmosphere for a pre-reduction treatment to obtain pre-reduced pellets having a metallization degree of 85 to 98%, an FeO content of 1 to 15%, and an MgO content of 0.5 to 10%.

In some embodiments, the FeO content of the pre-reduced pellets is 1 to 8 wt. %. In some embodiments, the FeO content of the pre-reduced pellets is 8 to 15 wt. %. In some embodiments, the FeO content of the pre-reduced pellets may be 1 wt. %, 5 wt. %, 10 wt. %, or 15 wt. %, or any value therebetween, e.g., 3 wt. %, 7 wt. %, or 12 wt. %. In some embodiments, the FeO content may be selected from a range of 1 to 15 wt. % based on actual requirements.

In some embodiments, the MgO content of the pre-reduced pellets is 0.5 to 3.5 wt. %. In some embodiments, the MgO content of the pre-reduced pellets is 3 to 6 wt. %. In some embodiments, the MgO content of the pre-reduced pellets may be 0.5 wt. %, 3 wt. %, 5 wt. %, 8 wt. %, or 10 wt. %, or any value therebetween, e.g., 1 wt. %, 4 wt. %, or 7 wt. %. In some embodiments, the MgO content may be selected from a range of 0.5 to 10 wt. % based on actual requirements.

The magnesium-based modifier refers to a compound containing magnesium, which functions to adjust properties of a slag in a subsequent smelting process, e.g., increasing a basicity of the slag, reducing a melting point or viscosity of the slag, thereby facilitating separation of the slag from the molten iron and enrichment of the vanadium-titanium. The mixture is a material obtained by uniformly mixing the above four components. More descriptions regarding the magnesium-based modifier may be found in the related descriptions below.

The pelletizing refers to a process in which powdery materials are formed into spherical particles through a drum, a disc, or other pelletizing equipment under actions of moisture and the binder.

The briquetting refers to a process in which the powdery materials are compacted under pressure into pellets having a certain shape (e.g., lumps or blocks).

By pelletizing or briquetting to prepare the carbon-containing pellets, an air permeability and a mechanical strength of the material can be improved, thereby facilitating subsequent pre-reduction and smelting processes.

The carbon-containing pellets are pellets containing a carbonaceous reductant that is formed through pelletizing or briquetting.

The hydrogen-containing atmosphere refers to an environmental atmosphere containing hydrogen (H₂). The hydrogen serves as a strong reductant and may participate in a reduction of iron oxides. More descriptions regarding the hydrogen-containing atmosphere may be found in the related descriptions below.

The pre-reduction treatment refers to partially reducing the material at a lower temperature before a main reduction reaction or smelting, aiming to improve subsequent reduction efficiency and reduce an energy consumption.

The metallization degree refers to a mass percentage of iron reduced to metallic iron in the pellets relative to a total iron content. In the present disclosure, both “metallization rate” and “metallization degree” refer to a mass percentage of metallic iron (Fe°) relative to a total iron (TFe) content in the pre-reduced pellets. For example, the metallization degree of the pre-reduced pellets may be 85 wt. %, 90 wt. %, 95 wt. %, or 98 wt. %, or any value therebetween, e.g., 88 wt. %, 92 wt. %, or 96 wt. %. In some embodiments, the metallization degree may be selected from a range of 85 to 98 wt. % based on actual requirements.

The pre-reduced pellets are a product obtained after the pre-reduction treatment, in which a portion of iron oxides has been reduced to the metallic iron.

In some embodiments, the pre-reduction treatment may be implemented in various ways, e.g., using equipment such as a shaft furnace, a rotary kiln, or a fluidized bed.

Step c: smelting and separating the pre-reduced pellets to obtain the molten iron and a vanadium-titanium-rich slag.

The smelting refers to a process of melting the material at a high temperature and causing reduction reactions to separate a metal from the slag.

The molten iron is iron in a molten state, usually containing carbon (C) and other alloying elements. The vanadium-titanium-rich slag is a molten slag formed during the smelting process and enriched with vanadium oxides and titanium oxides.

In some embodiments, the aforementioned countercurrent gravity separation is countercurrent tilt gravity separation by a tilted arrowhead revolving chute (TARC).

The TARC is an efficient gravity separation device. By utilizing a combined action of an inclined plane and countercurrent flow, more effective separation of the minerals can be achieved.

During the countercurrent gravity separation process, a feeding concentration may be controlled at 18 to 22%. In some embodiments, the feeding concentration may also be 20% to 22%. In some embodiments, the feeding concentration may also be 19 to 22%. In some embodiments, the feeding concentration may be 18%, 20%, or 22%, or any value therebetween, e.g., 19% or 21%. In some embodiments, the feeding concentration may be optimized based on specific ore properties and equipment characteristics.

In some embodiments, a feeding rate may be controlled at 100 to 150 L/min. In some embodiments, the feeding rate may be controlled at 100 to 130 L/min. In some embodiments, the feeding rate may be controlled at 120 to 150 L/min. In some embodiments, the feeding rate may be 100 L/min, 120 L/min, or 150 L/min, or any value therebetween, e.g., 110 L/min or 135 L/min.

In some embodiments, a water flow rate may be controlled at 14 to 18 L/min. In some embodiments, the water flow rate may be controlled at 14 to 16 L/min. In some embodiments, the water flow rate may be controlled at 16 to 18 L/min. In some embodiments, the water flow rate may be 14 L/min, 16 L/min, or 18 L/min, or any value therebetween, e.g., 15 L/min or 17 L/min. By precisely controlling parameters of the countercurrent gravity separation, a separation effect of the countercurrent gravity separation can be optimized, and a quality of the gravity separation rough concentrate can be improved.

In the iron-vanadium-titanium co-beneficiation concentrate, a total iron (TFe) content may be 40 to 50 wt. %. In some embodiments, the TFe content may be 40 wt. %, 45 wt. %, or 50 wt. %.

In some embodiments, a titanium dioxide (TiO₂) content may be 13 to 18 wt. %, and a vanadium pentoxide (V₂O₅) content may be 0.4 to 1.0 wt. %. The TiO₂ content may be 13 wt. %, 15 wt. %, or 18 wt. %. In some embodiments, the V₂O₅ content may be 0.4 wt. %, 0.7 wt. %, or 1.0 wt. %. The TiO₂ and V₂O₅ content indicators show that the iron-vanadium-titanium co-beneficiation concentrate has reached a high enrichment degree, providing a high-quality raw material for the subsequent reduction and smelting processes, which is beneficial for a subsequent recovery of vanadium and titanium.

In one or more embodiments of the present disclosure, by adopting a specific TARC and optimizing operating parameters, a co-enrichment recovery rate of iron, vanadium, and titanium is significantly improved, and a high-quality concentrate furnace charge meeting requirements of subsequent short-process smelting is stably obtained.

In some embodiments, reagents for the reverse flotation include a reverse flotation depressant and a reverse flotation collector. The function of the reverse flotation depressant is to prevent the target minerals from floating, while the function of the reverse flotation collector is to render surfaces of the gangue minerals hydrophobic, enabling the gangue minerals to attach to air bubbles and float upward.

The reverse flotation depressant may include one or more of starch, water glass, carboxymethyl cellulose, sodium hexametaphosphate, sodium silicate, and sodium fluosilicate. In some embodiments of the present disclosure, the reverse flotation depressant may be selected in various ways.

The reverse flotation collector may be one or more of oleic acid, linoleic acid, cetyl quaternary ammonium salt, tetradecyl quaternary ammonium salt, and sodium dimethylaminodecanoate. In some embodiments of the present disclosure, the reverse flotation collector may be selected in various ways.

In one or more embodiments of the present disclosure, by selecting appropriate reverse flotation reagents, selective removal of the aluminum- and silicon-bearing minerals can be achieved, thereby effectively improving a grade of the iron-vanadium-titanium co-beneficiation concentrate.

In some embodiments, the iron-vanadium-titanium co-beneficiation concentrate, the solid carbonaceous reductant, the binder, and the magnesium-based modifier are in a mass ratio of 100:3:1:1.5.

In some implementations of the present disclosure, by controlling a ratio of the iron-vanadium-titanium co-beneficiation concentrate, the solid carbonaceous reductant, the binder, and the magnesium-based modifier, good mixing of the materials can be achieved, and carbon-containing pellets with suitable properties can be prepared. This ratio can enable the carbon-containing pellets to achieve an optimal state in terms of mechanical strength, reduction activity, etc., providing stable raw materials for the subsequent pre-reduction and smelting processes.

In some embodiments, in step (b), the solid carbonaceous reductant may include one or a mixture of anthracite, bituminous coal, lignite, biomass, and biochar.

Different types of carbonaceous reductants have different fixed carbon contents, volatile matter contents, and reaction activities, and may be selected based on specific requirements and cost-effectiveness. For example, the anthracite has a high fixed carbon content and a strong reduction ability. The lignite has a high volatile matter content and is easy to ignite. The biomass and the biochar are renewable green reductants, which help reduce carbon emissions.

The binder may be one or a mixture of a composite binder, modified starch, and cellulose.

The composite binder is usually prepared by compounding a plurality of components to achieve more excellent binding performance.

The modified starch is treated by chemical or physical manners to improve binding strength and stability of the modified starch.

The cellulose, as a natural polymer substance, also has a good binding effect.

In some embodiments, a suitable binder or a combination thereof may be selected based on strength, drop resistance, and stability requirements of the carbon-containing pellets during the pre-reduction and the smelting.

In some embodiments of the present disclosure, the binder may also be other various substances capable of improving the mechanical strength of the carbon-containing pellets.

In some embodiments of the present disclosure, by adopting cost-controllable and flexible reductants and binders with the excellent binding performance, strength and stability of the pellets in a short-process vanadium-titanium ore process are effectively improved, thereby ensuring economy, stability, and high efficiency of an entire process.

In some embodiments, the solid carbonaceous reductant may be the biomass. The biomass has a fixed carbon content (FCd) of 15 to 20 wt. % and a volatile matter content (Vdaf)≥80 wt. %.

The fixed carbon content (FCd) refers to a mass percentage of solid carbon remaining after the biomass is heated under specified conditions.

The volatile matter content (Vdaf) refers to a mass percentage of gaseous substances volatilized after the biomass is heated under specified conditions.

For example, the fixed carbon content of the biomass may be 15 wt. %, 17.5 wt. %, or 20 wt. %. The volatile matter content may be 80 wt. %, 85 wt. %, 90 wt. %, or other values higher than 80 wt. %.

The biomass with a high volatile matter content can rapidly release reducing gases during the pre-reduction process, which helps accelerate a progress of the reduction reaction. For example, the biomass may include a wood chip, straw, a rice husk, etc.

In one or more embodiments of the present disclosure, by selecting a specific biomass with a high volatile matter content and a low fixed carbon content as the reductant, activity and efficiency of the reduction reaction are significantly improved, while simultaneously promoting a greening and environmental benefit of a short-process process.

In some embodiments, the magnesium-based modifier may include at least one of magnesium oxide, hydroxide, carbonate, chloride, nitrate, and organic acid salt.

Magnesium oxide (MgO) is one of the commonly used magnesium-based modifiers, directly providing a magnesium oxide component.

Magnesium hydroxide (Mg(OH)₂) decomposes at a high temperature to generate the magnesium oxide and water.

Magnesium carbonate (MgCO₃) decomposes at a high temperature to generate the magnesium oxide and carbon dioxide.

Magnesium chloride (MgCl₂), magnesium nitrate (Mg(NO₃)₂), and various magnesium organic acid salts may also serve as magnesium sources to provide magnesium ions for adjusting the properties of the slag during the smelting process.

In some embodiments of the present disclosure, the magnesium-based modifier may also be various other compounds capable of providing the magnesium elements.

In some embodiments, a weight ratio of the iron-vanadium-titanium co-beneficiation concentrate to the magnesium-based additive may be 100:(1~3).

In one or more embodiments of the present disclosure, by providing a plurality of optional magnesium-based modifiers, flexibility and economy of raw material selection are enhanced, while properties of the slag during the smelting process are effectively optimized, ensuring high efficiency of vanadium and titanium extraction and stable operation of the equipment.

In one or more embodiments of the present disclosure, the co-enriched iron-vanadium-titanium co-beneficiation concentrate is subjected to a magnesium oxide-assisted internal carbon charging-gas-solid pre-reduction treatment. By jointly controlling parameters such as a metallization degree, an FeO content, and an MgO content of the pre-reduced product, reaction behaviors and enrichment directions of iron, vanadium, and titanium during a subsequent reduction process can be unexpectedly optimized. This facilitates a high-selectivity separation of the molten iron and a vanadium-titanium slag. Furthermore, the approach facilitates joint control of a slag phase and physicochemical characteristics of the vanadium-titanium slag, thereby facilitating subsequent selective separation of the vanadium and titanium from the vanadium-titanium slag.

In some embodiments, each of the carbon-containing pellets have a diameter of 10 to 20 mm. In some embodiments, a diameter of the carbon-containing pellet is 10 to 15 mm. In some embodiments, the diameter of the carbon-containing pellet is 15 to 20 mm. For example, the diameter of the carbon-containing pellet may be 10 mm, 12 mm, 15 mm, 18 mm, or 20 mm, or any value therebetween.

In some embodiments, the diameter of the carbon-containing pellet may be controlled by adjusting parameters of pelletizing or briquetting equipment.

In some embodiments of the present disclosure, by controlling the size range, a good permeability of the carbon-containing pellets in a pre-reduction furnace and a smelting furnace is ensured, while a sufficient mechanical strength is guaranteed to prevent crushing, facilitating gas-solid contact, thereby improving reduction efficiency and smoothness of subsequent smelting.

In some embodiments, during the pre-reduction treatment, a volume fraction of H₂ in the hydrogen-containing atmosphere is greater than or equal to 15%. For example, the volume fraction of H₂ may be 15%, 20%, 30%, or higher.

In some embodiments, a pre-reduction temperature may be 900 to 1200 °C. In some embodiments, the pre-reduction temperature may be 900 to 1050 °C. In some embodiments, the pre-reduction temperature may be 1050 to 1200 °C. For example, the pre-reduction temperature may be 900 °C, 1000 °C, 1100 °C, or 1200 °C, or any value therebetween, e.g., 950 °C or 1050 °C.

In some embodiments, a pre-reduction time may be 10 to 90 min. In some embodiments, the pre-reduction time may be 10 to 50 min. In some embodiments, the pre-reduction time may be 50 to 90 min. For example, the pre-reduction time may be 10 min, 30 min, 60 min, or 90 min, or any value therebetween, e.g., 20 min or 45 min. In some embodiments, the pre-reduction temperature and the pre-reduction time may be adjusted based on factors such as a furnace type, a pellet size, and a hydrogen concentration to achieve an optimal reduction effect.

In some embodiments, the pre-reduction temperature may be 950 to 1050 °C. For example, the pre-reduction temperature may be 950 °C, 980 °C, 1000 °C, 1020 °C, or 1050 °C. The pre-reduction time may be 30 to 60 min. For example, the pre-reduction time may be 30 min, 40 min, 50 min, or 60 min.

In some embodiments of the present disclosure, by introducing the hydrogen-containing atmosphere during the pre-reduction treatment and controlling an appropriate hydrogen concentration, a driving force for the reduction reaction is increased, a reduction process of the iron oxides is accelerated, thereby effectively increasing the metallization degree, and reducing energy consumption of the subsequent smelting. Simultaneously, by controlling proportions of various components and pre-reduction conditions, a performance of a product is optimized, achieving an effective separation and recovery of valuable components such as iron, vanadium, and titanium, thereby improving comprehensive utilization value and economic benefits of resources.

In some embodiments of the present disclosure, by controlling an appropriate temperature and a time range, the pre-reduction process is further optimized, ensuring a high metallization degree while the reduction reaction proceeds effectively, and simultaneously avoiding pellet softening and agglomeration caused by excessively high temperatures, reducing energy consumption, and improving production efficiency.

In some embodiments, the metallization degree of the pre-reduced pellets is 90 to 97 wt. %. In some embodiments, the metallization degree of the pre-reduced pellets is 90 to 94 wt. %. In some embodiments, the metallization degree of the pre-reduced pellets is 93 to 97 wt. %. In some embodiments, the metallization degree may be 90 wt. %, 93 wt. %, 95 wt. %, or 97 wt. %.

In some embodiments, the FeO content of the pre-reduced pellets is 1 to 15 wt. %. In some embodiments, the FeO content of the pre-reduced pellets is 1 to 8 wt. %. In some embodiments, the FeO content of the pre-reduced pellets is 8 to 15 wt. %. In some embodiments, the FeO content may be 1 wt. %, 5 wt. %, 10 wt. %, or 15 wt. %.

In some embodiments, the MgO content of the pre-reduced pellets is 0.5 to 10 wt. %. In some embodiments, the MgO content of the pre-reduced pellets is 0.5 to 5.5 wt. %. In some embodiments, the MgO content of the pre-reduced pellets is 5.5 to 10 wt. %. In some embodiments, the MgO content may be 0.5 wt. %, 3 wt. %, 7 wt. %, or 10 wt. %.

In some embodiments, the aforementioned indicators (e.g., the metallization degree, the FeO content, and the MgO content of the pre-reduced pellets) may be achieved by adjusting the pre-reduction conditions, for example, by adjusting the volume fraction of H₂ in the hydrogen-containing atmosphere, the pre-reduction temperature, the pre-reduction time, etc.

In one or more embodiments of the present disclosure, by controlling the metallization degree, the FeO content, and the MgO content of the pre-reduced pellets, reduction and distribution behaviors of Fe, vanadium, and titanium during the subsequent reduction and smelting and separation are optimized, thereby ensuring that the pre-reduced pellets have a higher reduction rate. This also facilitates regulation and formation of an active vanadium-titanium slag phase that is conducive to an extraction and separation of vanadium and titanium, provides a superior raw material for the subsequent smelting, and helps to reduce smelting energy consumption and improve efficiency.

In some embodiments, the FeO content of the pre-reduced pellets is 3 to 10 wt. %. In some embodiments, the FeO content of the pre-reduced pellets is 3 to 7 wt. %. In some embodiments, the FeO content of the pre-reduced pellets is 6 to 10 wt. %. In some embodiments, the FeO content may be 3 wt. %, 5 wt. %, 8 wt. %, or 10 wt. %.

In some embodiments, the MgO content of the pre-reduced pellets is 2 to 8.5 wt. %. In some embodiments, the MgO content of the pre-reduced pellets is 2 to 5.5 wt. %. In some embodiments, the MgO content of the pre-reduced pellets is 5 to 8.5 wt. %. In some embodiments, the MgO content may be 2 wt. %, 4 wt. %, 6 wt. %, or 8.5 wt. %.

By controlling ranges of the FeO content and the MgO content, chemical compositions of the pre-reduced pellets are further optimized, thereby facilitating formation of a more ideal slag system during the subsequent smelting process, improving an enrichment rate of vanadium and titanium, and obtaining molten iron with a superior quality.

In some embodiments, a smelting-separation temperature is 1300 to 1600 °C. In some embodiments, the smelting-separation temperature is 1300 to 1500 °C. In some embodiments, the smelting-separation temperature is 1400 to 1600 °C. In some embodiments, the smelting-separation temperature may be 1300 °C, 1400 °C, 1500 °C, or 1600 °C, or any value therebetween, e.g., 1350 °C or 1450 °C.

In some embodiments, a smelting time is 0.5 to 4 h. In some embodiments, the smelting time is 0.5 to 2.5 h. In some embodiments, the smelting time is 2 to 4 h. In some embodiments, the smelting time may be 0.5 h, 1 h, 2 h, 3 h, or 4 h, or any value therebetween, e.g., 1.5 h or 2.5 h. In some embodiments, the smelting-separation temperature and the smelting time may be adjusted based on the furnace type, the pellet property, and desired compositions of the molten iron and the slag.

In some embodiments, the smelting-separation temperature is 1350 to 1450 °C. In some embodiments, the smelting-separation temperature is 1350 to 1400 °C. In some embodiments, the smelting-separation temperature is 1400 to 1450 °C. In some embodiments, the smelting-separation temperature may be 1350 °C, 1380 °C, 1400 °C, 1420 °C, or 1450 °C.

In some embodiments, by controlling a range of the smelting-separation time, a sufficient reaction time is ensured to fully reduce metal oxides and to form a clear liquid phase separation between the molten iron and the vanadium-titanium-rich slag. In addition, by controlling a range of the melting-separation temperature, efficient smelting and separation are achieved with optimized energy consumption, while facilitating control of a valence state and enrichment degree of vanadium and titanium in the slag, thereby ensuring that the molten iron and slag are fully melted and well separated.

In some embodiments, after obtaining the vanadium-titanium-rich slag, the vanadium-titanium-rich slag may be further processed to recover vanadium and titanium. The process includes subjecting the vanadium-titanium-rich slag to crushing and fine grinding, and then subjecting to acid leaching to obtain a vanadium-bearing leach solution and a titanium slag. Vanadium is recovered from the vanadium-bearing leach solution, and titanium is recovered from the titanium slag.

A purpose of crushing and fine grinding is to increase a surface area of the vanadium-titanium-rich slag, making the vanadium-titanium-rich slag easier to contact an acid solution and improving acid leaching efficiency.

The acid leaching refers to soaking and reacting a finely ground vanadium-titanium-rich slag with the acid solution, thereby allowing vanadium in the vanadium-titanium-rich slag to enter the acid solution in a form of soluble compounds, while titanium mainly remains in the slag that is insoluble.

The vanadium-bearing leach solution is an acidic solution containing dissolved vanadium.

The titanium slag is a solid residue remaining after the acid leaching process, in which titanium is enriched.

By deeply processing the vanadium-titanium-rich slag, a comprehensive recovery of two high-value elements, vanadium and titanium, can be achieved, thereby further improving economic benefits and resource utilization rate of an entire process.

In some embodiments, the vanadium-bearing leach solution may also be separated by other processes.

In some embodiments, the vanadium-titanium-rich slag, after crushing and fine grinding, has a particle size controlled such that a content of −0.074 mm fraction is ≥90%. This means that more than 90% of material particles are smaller than 0.074 mm. For example, the content of −0.074 mm fraction may be 90%, 92%, 95%, or 98%.

The acid solution used for the acid leaching is hydrochloric acid (HCl). The hydrochloric acid is a commonly used leaching agent with a strong dissolving power. In some embodiments, an initial hydrochloric acid concentration is 10% to 25%.

In some embodiments, the initial hydrochloric acid concentration may be 10% to 15%.

In some embodiments, the initial hydrochloric acid concentration may be 15% to 25%. In some embodiments, the initial hydrochloric acid concentration may be 10%, 15%, 20%, or 25%, or any value therebetween. An excessively low acid concentration may result in incomplete leaching, while an excessively high concentration may increase corrosion and cost.

In some embodiments, an acid-to-slag mass ratio is (2:1) to (6:1). In some embodiments, the acid-to-slag mass ratio may be 2:1, 3:1, 4:1, 5:1, or 6:1.

In some embodiments, a leaching temperature is 30 to 160 °C. In some embodiments, the leaching temperature is 30 to 100 °C. In some embodiments, the leaching temperature may be 90 to 160 °C. In some embodiments, the leaching temperature may be 30 °C, 60 °C, 100 °C, 130 °C, or 160 °C. An increase in temperature typically accelerates a leaching reaction.

In some embodiments, a leaching time is 0.5 to 5 h. In some embodiments, the leaching time may be 0.5 to 3.5 h. In some embodiments, the leaching time may be 2.5 to 5 h. In some embodiments, the leaching time may be 0.5 h, 1 h, 2 h, 3 h, 4 h, or 5 h.

The vanadium is extracted and separated from the vanadium-bearing leach solution, and a vanadium pentoxide (V₂O₅) product is prepared. Extraction and separation is a liquid-liquid separation technique that achieves separation and enrichment by utilizing differences in distribution coefficients of different substances between two immiscible solvents. Through the extraction and separation, the vanadium can be efficiently extracted and purified from the vanadium-bearing leach solution, and finally prepared into a high-grade vanadium pentoxide product.

The titanium slag has a TiO₂ grade≥50%. For example, the TiO₂ grade may be 50%, 55%, 60%, or higher. A high-grade titanium slag indicates that after vanadium leaching, a titanium element is effectively enriched and serves as a high-quality raw material for titanium recovery. The titanium slag is used to prepare titanium dioxide powder (TiO₂).

The titanium dioxide powder is an important white pigment used in industries such as coatings, plastics, and papermaking. By further processing the high-grade titanium slag into the titanium dioxide powder, deep and high-value utilization of the titanium may be achieved. In some embodiments, the titanium slag may also be processed into other titanium products, such as sponge titanium, a titanium alloy, etc.

In some embodiments, these parameters may be adjusted based on compositions of the slag and desired leaching efficiency. A sufficiently long leaching time ensures full dissolution of vanadium. Such a fine grinding degree can significantly increase a specific surface area of the slag, greatly improving efficiency and a leaching rate of a subsequent acid leaching reaction. This acid-to-slag ratio ensures an adequate amount of acid to dissolve vanadium while avoiding waste caused by an excessive acid solution.

In some embodiments, the initial hydrochloric acid concentration is 20%. The acid-to-slag mass ratio is 3:1. The leaching temperature is 60 °C. The leaching time is 2 h.

By controlling acid leaching parameters, efficient vanadium leaching can be achieved. While ensuring a high leaching rate, economy and operational convenience are also considered, thereby optimizing the leaching process.

One or more embodiments of the present disclosure break away from existing conventional concepts of iron and titanium separation in the raw ore, and innovatively provide a short-process recovery concept of raw ore including co-enrichment (countercurrent gravity separation-reverse flotation)-co-smelting (magnesium oxide-assisted internal carbon charging-gas-solid pre-reduction-melting and separation). The raw ore is first subjected to the countercurrent gravity separation for tailing removal and the reverse flotation to obtain a co-beneficiation concentrate (co-enriched minerals) containing the ilmenite and the vanadium-titanium magnetite in the raw ore. The co-beneficiation concentrate is then subjected to the pre-reduction with carbon and hydrogen assistance, while strictly controlling parameters such as the metallization degree of iron, the FeO content, and the MgO content during the pre-reduction process. Based on unique physicochemical characteristics of the pre-reduced minerals, subsequent smelting and separation processes are carried out, thereby regulating reaction behaviors and element distributions of iron, vanadium, and titanium. As a result, iron is highly selectively enriched in the molten iron, whereas vanadium and titanium are highly selectively enriched in the vanadium-titanium slag, thus realizing selective smelting and separation of iron and the vanadium-titanium and facilitating control of slag phases to improve a selective recovery performance of the vanadium and the titanium in the vanadium-titanium slag.

One or more embodiments of the present disclosure provide a novel concept for co-enrichment of the vanadium-titanium magnetite via a special countercurrent gravity separation and reverse flotation for silicon-aluminum removal. A special co-smelting treatment including pre-reduction-smelting and separation is applied to this specially co-enriched iron-vanadium-titanium co-beneficiation concentrate. This not only significantly shortens a processing route and avoids a use of blast furnaces and harmful arsenic reagents found in existing technologies, but also remarkably improves an overall recovery rate of the vanadium-titanium magnetite. For example, final utilization rates of vanadium and titanium can be increased from current 44% and 29%, respectively, to over 80%.

One or more embodiments of the present disclosure provide an optional method for short-process and high-value utilization of the vanadium-titanium magnetite resources, aiming to solve problem of low recovery and utilization rates of components such as titanium, vanadium, nickel, and cobalt in existing beneficiation and metallurgical processes. The method mainly includes following steps:
(1) subjecting a raw vanadium-titanium magnetite ore to crushing, grinding, and countercurrent tilt gravity separation to obtain a pre-concentration rough concentrate; subjecting the rough concentrate directly to reverse flotation to obtain an iron-vanadium-titanium co-beneficiation concentrate, or performing desulfurization flotation to recover valuable elements such as nickel and cobalt, and then performing the reverse flotation to obtain the iron-vanadium-titanium co-beneficiation concentrate; furthermore, subjecting the tailings obtained after gravity pre-concentration to magnetic separation to recover iron minerals, and combining the iron minerals into the co-beneficiation concentrate;
(2) mixing the iron-vanadium-titanium co-beneficiation concentrate obtained in step (1), a solid carbonaceous reductant, a binder, and a magnesium-based modifier in a mass ratio of 100:(1-10):(0.5-3):(1-3) to obtain a mixture; and pelletizing or briquetting the mixture to prepare carbon-containing pellets with a diameter of 10 to 20 mm;
(3) subjecting the carbon-containing pellets in a hydrogen-rich reducing gas for reduction to obtain pre-reduced pellets with a certain metallization degree;
(4) charging the pre-reduced pellets obtained in step (3) into an electric furnace and performing smelting and separation to obtain molten iron and a vanadium-titanium-rich slag; the molten iron being used for converter steelmaking;
(5) subjecting the vanadium-titanium-rich slag obtained in step (4) to crushing and fine grinding, and then performing acid leaching and extraction and separation to recover vanadium and produce a vanadium pentoxide product; and
(6) utilizing a titanium-rich residue remaining after the acid leaching in step (5) for producing a titanium dioxide powder;
In the above method, a particle size of the raw vanadium-titanium magnetite ore after crushing and grinding in step (1) may be controlled such that a content of −0.15 mm fraction is ≥95%.

In the above method, in step (1), a feeding concentration for the gravity separation is 18 to 22%, a feeding rate is controlled at 100 to 150 L/min, and a water flow rate is controlled at 14 to 18 L/min. This yields an iron-vanadium-titanium co-beneficiation rough concentrate with a TFe content of 40 to 50 wt. %, a TiO₂ content of 13 to 18 wt. %, a V₂O₅ content of 0.4 to 1.0 wt. %, and an MgO content of 0.4 to 8 wt. %.

In step (1), a magnetic separation intensity is 0.2 to 0.4 T.

In the desulfurization flotation and de-aluminosilicate reverse flotation, a pulp concentration is controlled at 20% to 40%, and a pH is in a range of 6 to 11.

In one or more embodiments of the present disclosure, flotation reagents used in the desulfurization flotation process include a desulfurization modifier and a desulfurization collector.

The desulfurization modifier includes at least one of sulfuric acid, the hydrochloric acid, sodium hydroxide, and lime.

The desulfurization collector includes at least one of xanthate collector, aerofloat collector, and sulfur-nitrogen collector; preferably, the desulfurization collector includes at least one of ethyl xanthate, butyl xanthate, isopropyl xanthate, isobutyl xanthate, amyl xanthate, hexyl xanthate, butylammonium dithiophosphate, and ethylthionamide.

The desulfurization flotation process includes one roughing stage and two scavenging stages. A dosage of the desulfurization modifier in the roughing stage is 400 to 800 g/t, a dosage of the desulfurization modifier in a first scavenging stage is 200 to 400 g/t, and a dosage of the desulfurization modifier in a second scavenging stage is 0 to 200 g/t.

A dosage of the desulfurization collector in the roughing stage is 80 to 200 g/t, a dosage of the desulfurization collector in the first scavenging stage is 40 to 80 g/t, and a dosage of the desulfurization collector in the second scavenging stage is 0 to 40 g/t.

In one or more embodiments of the present disclosure, the de-aluminosilicate reverse flotation can remove the minerals such as Al and Si from the gravity separation concentrate in a form of flotation froth. Furthermore, the de-aluminosilicate reverse flotation can optimize a composition of components such as Mg in minerals of reverse flotation tailings.

Preferably, reagents for the de-aluminosilicate reverse flotation (also referred to as reverse flotation for silicon-aluminum removal) include a reverse flotation depressant and a reverse flotation collector.

The reverse flotation depressant includes at least one of the starch, the water glass, the carboxymethyl cellulose, the sodium hexametaphosphate, the sodium silicate, and the sodium fluosilicate.

Preferably, the reverse flotation collector includes at least one of the oleic acid, the linoleic acid, the cetyl quaternary ammonium salt, the tetradecyl quaternary ammonium salt, and the sodium dimethylaminodecanoate.

In the reverse flotation for the silicon-aluminum removal, a frother and an activator may also be added as needed.

In one or more embodiments of the present disclosure, the activator is a conventional component capable of achieving de-aluminosilicate reverse flotation, for example, the activator is calcium chloride.

A process of the reverse flotation for the silicon-aluminum removal may include one roughing stage and 1-3 scavenging stages.

In one or more embodiments of the present disclosure, when the raw ore also contains sulfide minerals of at least one metal selected from nickel, cobalt, and scandium, a desulfurization treatment may be performed in advance on a countercurrent gravity separation concentrate based on desulfurization requirements, followed by subsequent reverse flotation for the silicon-aluminum removal.

The de-aluminosilicate reverse flotation includes one roughing stage and two scavenging stages. A dosage of the depressant in the roughing stage is 250 to 2000 g/t (further, the dosage in the roughing stage may be 750 to 850 g/t). A dosage of the depressant in a first scavenging stage is 50 to 600 g/t (further, the dosage in the first scavenging stage may be 450 to 500 g/t). A dosage of the depressant in a second scavenging stage is 50 to 400 g/t (further, the dosage in the second scavenging stage may be 250 to 300 g/t).

A dosage of the collector in the roughing stage of the de-aluminosilicate reverse flotation is 250 to 2000 g/t (further, the dosage may be 900 to 1100 g/t). A dosage of the collector in the first scavenging stage is 50 to 600 g/t (further, the dosage may be 450 to 500 g/t). A dosage of the collector in the second scavenging stage is 50 to 400 g/t (further, the dosage may be 250 to 300 g/t).

The reagents for the reverse flotation for the silicon-aluminum removal may also allow an addition of the frother. A dosage of the frother in the roughing stage may be 40 to 120 g/t (further, the dosage may be 70 to 90 g/t). A dosage of the frother in the first scavenging stage is 20 to 60 g/t (further, the dosage may be 30 to 50 g/t). A dosage of the frother in the second scavenging stage is 10 to 30 g/t (further, the dosage may be 15 to 25 g/t).

The reagents for the reverse flotation for the silicon-aluminum removal may also allow an addition of the activator. The activator may be calcium chloride.

A dosage of the activator in the roughing stage may be 400 to 600 g/t (further, the dosage may be 450 to 550 g/t). A dosage of the activator in the first scavenging stage is 100 to 300 g/t (further, the dosage may be 150 to 250 g/t). A dosage of the activator in the second scavenging stage is 50 to 150 g/t (further, the dosage may be 80 to 120 g/t).

In the above method, in step (2), the solid carbonaceous reductant is one or a mixture of the anthracite, the bituminous coal, the lignite, the biomass, and the biochar. Preferably, the solid carbonaceous reductant is the biomass. The biomass has a fixed carbon content (FCd) of 15 to 20 wt. % and a volatile matter content (Vdaf) of ≥80 wt. %.

In the present disclosure, the terms “the magnesium-based modifier” and “the magnesium-based additive” are used interchangeably, and both refer to one or a mixture of one or more compounds, including but not limited to, the magnesium oxide, the hydroxide, the carbonate, dolomite, and processed products of the dolomite such as light-burned dolomite and magnesite, which are common magnesium-based fluxes.

The iron-vanadium-titanium co-beneficiation concentrate obtained in step (2), the solid carbonaceous reductant, the binder, and the magnesium-based modifier are mixed according to a mass ratio of 100:(2.5-3.5):(1-1.5):(1.25-1.75) to obtain a mixture.

The obtained iron-vanadium-titanium co-beneficiation concentrate, the solid carbonaceous reductant, the binder, and the magnesium-based modifier are mixed according to a mass ratio of 100:3:1:1.5 to obtain the mixture.

The binder includes at least one of the composite binder, the modified starch, and the cellulose. Preferably, the binder is a coal-based colloidal composite binder, preparation and composition of which are described in the Chinese Patent Application No. CN117305581A.

A purpose of adding the magnesium-based flux in one or more embodiments of the present disclosure is to replace a calcium-based flux to reduce slag viscosity. When a reduction degree of the pre-reduced pellets is high, an FeO content in the slag during the subsequent smelting and separation is low. Increasing magnesium oxide in the slag can reduce the slag viscosity, increase the iron recovery rate, and change an occurrence state of titanium in the slag.

A volume fraction of H₂ in the reducing gas is greater than or equal to 15%. In a further preferred embodiment, the reducing gas includes one or a mixture of H and CO, in which the volume fraction of H₂ is greater than or equal to 15%. It is further preferred that H₂ is used to pre-reduce the carbon-containing pellets.

The pre-reduction temperature is 900 to 1200 °C, and the pre-reduction time is 10 to 90 min. Further preferably, the pre-reduction temperature is 950 to 1050 °C, and the pre-reduction time is 15 to 60 min. An excessively high pre-reduction temperature causes excessive reduction of high-valence iron oxides (containing trivalent iron and divalent iron) to the metallic iron, resulting in an overly low FeO content in the pre-reduced pellets, which cannot serve a conditioning role in the subsequent process. An excessively low pre-reduction temperature results in an overly low metallization degree of the pre-reduced pellets, an overly high FeO content in the slag during the smelting and separation, and a reduced iron recovery rate.

The pre-reduced pellets have an FeO content of 1 to 15 wt. % and an MgO content of 0.5 to 10 wt. %. Further preferably, the pre-reduced pellets have an FeO content of 3 to 10 wt. % and an MgO content of 2 to 8.5 wt. %.

The smelting-separation temperature is 1300 to 1600 °C, preferably 1350 to 1450 °C, and a reduction time is 0.5 to 4 h.

With the above configuration, a temperature at which a molten slag viscosity reaches 0.5 Pa·s can be reduced to a range of 1350 to 1450 °C. The obtained iron sample has a TFe content of ≥98 wt. %, and a vanadium-titanium-rich slag has a TiO₂ content of ≥40 wt. %, and further preferably above 50 wt. %.

The vanadium-titanium-rich slag, after crushing and fine grinding, has the particle size controlled such that a content of −0.074 mm fraction is ≥90%. The initial hydrochloric acid concentration for the acid leaching is 10 to 25%, the acid-to-slag mass ratio is 2:1 to 6:1, the leaching temperature is 30 to 160 °C, and the leaching time is 0.5 to 5 h.

The titanium-rich material has a TiO₂ grade of ≥50% and may be directly used for the titanium dioxide powder production.

In the above method, gravity separation equipment used is a countercurrent tilt gravity separation column. Merely by way of example, the gravity separation equipment may be the TARC. As an optional solution, this embodiment selects the gravity separation equipment disclosed in the Chinese Patent Application No. CN117414938A.

In following embodiments, the selected hydrogen is a commercial hydrogen-rich atmosphere. For example, the commercial hydrogen-rich atmosphere has a hydrogen content above 95%.

In one or more embodiments of the present disclosure, the iron-vanadium-titanium co-beneficiation concentrate is co-enriched with the ilmenite and the vanadium-titanium magnetite from the raw ore, which is different from conventional separation processes. A weight ratio of the ilmenite to the vanadium-titanium magnetite may be 1:2 to 3.

### Embodiment 1

This embodiment selected a raw vanadium-titanium magnetite ore from a concentrator in Baima, Panzhihua. The chemical composition analysis of the raw vanadium-titanium magnetite ore is shown in Table 1.

TABLE 1
Chemical composition analysis of raw vanadium-titanium
magnetite ore from the concentrator in Baima, Panzhihua

| | Element | | | | | | | |
|---|---|---|---|---|---|---|---|---|
| | TFe | FeO | SiO₂ | MgO | Al₂O₃ | TiO₂ | CaO | V₂O₅ |
| Grade/% | 26.99 | 19.79 | 27.30 | 9.80 | 9.33 | 6.56 | 5.34 | 0.28 |

This embodiment specifically includes following steps.

(1) The raw vanadium-titanium magnetite ore is fed into a first-stage crushing operation for crushing and grinding; a fineness of a ground product is controlled such that a content of −0.15 mm fraction is ≥70 wt. %.

(2) The ground product obtained in step (1) is fed into a first-stage TARC for countercurrent tilt gravity separation; where a feeding concentration is controlled at 25%, a feeding rate is controlled at 120 L/min, and a water flow rate is controlled at 16 L/min; an underflow obtained from the separation is used as a gravity separation rough concentrate of the first-stage TARC and an overflow is used as tailings for direct disposal.

The gravity separation rough concentrate of the first-stage TARC is fed to a second-stage TARC for gravity separation operation. The feeding concentration is controlled at 25%, the feeding rate is controlled at 120 L/min, and the water flow rate is controlled at 16 L/min. The underflow obtained from the separation is used as a final iron-vanadium-titanium co-enrichment co-beneficiation concentrate (in the present disclosure, the term “iron-vanadium-titanium co-enrichment co-beneficiation concentrate” and the term “iron-vanadium-titanium co-beneficiation concentrate” are used interchangeably and considered to have equivalent meanings, both referring to a concentrate product in which three elements, iron (Fe), vanadium (V), and titanium (Ti), are all enriched). The overflow obtained from the separation is used as tailings for direct disposal. The tailings obtain by gravity separation of the first-stage TARC and the tailings obtain by gravity separation of the second-stage TARC are combined as the tailings. Indicators of the co-beneficiation concentrate (gravity separation concentrate) and the tailings obtained according to the above steps are shown in Table 2.

TABLE 2
Implementation results of co-enrichment of iron, titanium,
and vanadium from vanadium-titanium magnetite

| | | TFe | | TiO₂ | | V₂O₅ | |
|---|---|---|---|---|---|---|---|
| Product | Yield/% | Grade/% | Recovery/% | Grade/% | Recovery/% | Grade/% | Recovery/% |
| Co-beneficiation | 61.25 | 49.33 | 79.36 | 14.19 | 84.71 | 0.59 | 82.50 |
| concentrate | | | | | | | |
| Tailings | 38.75 | 18.17 | 20.64 | 4.25 | 15.29 | 0.20 | 17.50 |

(3) The gravity separation concentrate obtained in step (2) is subjected to reverse flotation for silicon-aluminum removal, which includes one roughing stage and two scavenging stages (a first scavenging stage and a second scavenging stage); the steps are as follows: carrying out rough flotation on the gravity separation concentrate to obtain roughing tailings; subjecting the roughing tailings to first scavenging, and then subjecting tailings after the first scavenging to second scavenging; and collecting tailings after the second scavenging as the iron-vanadium-titanium co-beneficiation concentrate.

Flotation reagents for the roughing stage, the first scavenging stage, and the second scavenging stage include a frother, a collector, an activator, and a depressant. The frother is No. 2 oil. The depressant is starch. The activator is calcium chloride. The collector is oleic acid.

In the roughing stage, a dosage of the frother is 80 g/t, a dosage of the depressant is 800 g/t, a dosage of the activator is 500 g/t, and a dosage of the collector is 1000 g/t.

In the first scavenging stage, the dosage of the frother is 40 g/t, the dosage of the depressant is 500 g/t, the dosage of the activator is 200 g/t, and the dosage of the collector is 500 g/t.

In the second scavenging stage, the dosage of the frother is 20 g/t, the dosage of the depressant is 300 g/t, the dosage of the activator is 100 g/t, and the dosage of the collector is 300 g/t.

(4) The iron-vanadium-titanium co-beneficiation concentrate obtained in step (3) is mixed with a biomass (sawdust), a composite binder (with Mad=8.49 wt. %, Ad=28.73 wt. %, and Vdaf=60.86 wt. %), and magnesite at a mass ratio of 100:5:1:1.5 to obtain a mixture; and the mixture is then subjected to a pelletizing process to prepare carbon-containing pellets with a diameter of 10 mm to 14 mm through a pelletizing process.

(5) The carbon-containing pellets obtained in step (4) are subjected to reduction at a reduction temperature of 1050 °C for 30 minutes in a H₂ atmosphere to obtain pre-reduced pellets with a metallization degree of 94.43 wt. %, an FeO content of 5.63 wt. %, and an MgO content of 4.42 wt. %.

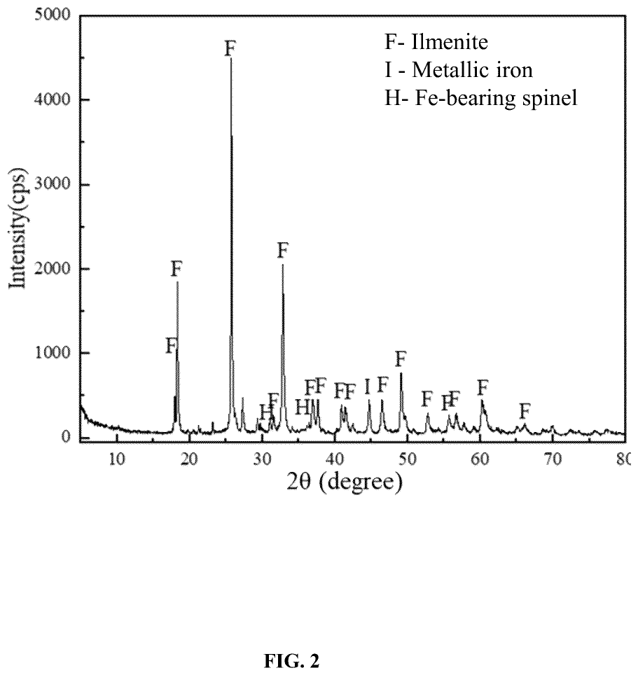

(6) The pre-reduced pellets obtained in step (5) are mixed with the sawdust amounting to 0.3 wt. % of the pre-reduced pellets, and are subjected to reduction, smelting and separation at 1450 °C for 1 h to obtain molten iron and a vanadium-titanium-rich slag. The obtained iron sample has a TFe content of 99.8 wt. % and an iron recovery rate of 88.73%. The vanadium-titanium-rich slag (whose XRD is shown in FIG. 2) has a TiO₂ grade above 50 wt. %, a titanium recovery rate of 95 wt. %, a V₂O₅ grade of 1.3 wt. %, and a vanadium recovery rate of 85 wt. %.

(7) The vanadium-titanium-rich slag, after crushing and fine grinding, has a particle size controlled such that a content of −0.074 mm fraction is ≥90%. Acid leaching is performed. An initial hydrochloric acid concentration for the acid leaching is 20%. An acid-to-slag mass ratio is 3:1. A leaching temperature is 60 °C. A leaching time is 2 h. Subsequently, solid-liquid separation is performed to obtain a vanadium-bearing leach solution and a vanadium-leached residue. A vanadium leaching rate is 86.8%.

An acid digestion rate of the vanadium-leached residue (titanium slag) with 95% concentrated sulfuric acid is 94.0%. The vanadium-leached residue (the titanium slag) may be used as a raw material for producing titanium dioxide powder by a sulfuric acid manner.

### Embodiment 2

Compared with Embodiment 1, the difference lies only in a modification of steps (4) to (6), specifically as follows.

(4) The iron-vanadium-titanium co-beneficiation concentrate is mixed with a biomass (sawdust), a composite binder (with Mad=8.49 wt. %, Ad=28.73 wt. %, and Vdaf=60.86 wt. %), and magnesite at a mass ratio of 100:3:1:1.5 to obtain a mixture, and the mixture is then subjected to a pelletizing process to prepare carbon-containing pellets with a diameter of 10 mm to 14 mm.

(5) The carbon-containing pellets obtained in step (4) are subjected to reduction at a reduction temperature of 1050 °C for 15 minutes in a H₂ atmosphere to obtain pre-reduced pellets with a metallization degree of 87.87 wt. %, an FeO content of 11.22 wt. %, and an MgO content of 3.09 wt. %.

(6) The pre-reduced pellets obtained in step (5) are mixed with a reductant (sawdust) at a mass ratio of 100:0.5, and are subjected to reduction, smelting and separation at 1450 °C for 1 h to obtain molten iron and a vanadium-titanium-rich slag. The obtained iron sample has a TFe content of 99.8 wt. % and an iron recovery rate of 80.91%. The vanadium-titanium-rich slag has a TiO₂ grade above 50 wt. %.

A titanium recovery rate is 97.3 wt. %. A V₂O₅ grade is 1.2 wt. %. A vanadium recovery rate is 92.5 wt. %.

(7) This step is the same as step (7) in Embodiment 1, and a vanadium leaching rate is 86.2%.

An acid digestion rate of the vanadium-leached residue (titanium slag) with 95% concentrated sulfuric acid is 97%.

### Embodiment 3

Compared with Embodiment 1, the difference lies only in a modification of steps (4) to (6), specifically as follows.

(4) The iron-vanadium-titanium co-beneficiation concentrate is mixed with a biomass (sawdust), a composite binder (with Mad=8.49%, Ad=28.73%, and Vdaf=60.86%), and magnesite at a mass ratio of 100:3:1:1.5 to obtain a mixture. The mixture is then subjected to a pelletizing process to prepare carbon-containing pellets with a diameter of 10 to 14 mm.

(5) The carbon-containing pellets obtained in step (4) are subjected to reduction at a reduction temperature of 1000 °C for 60 minutes in a H₂ atmosphere to obtain pre-reduced pellets with a metallization degree of 96.57 wt. %, an FeO content of 3.54 wt. %, and an MgO content of 5.87 wt. %.

(6) The pre-reduced pellets obtained in step (5) are mixed with a reductant at a mass ratio of 100:0.5, and c are subjected to reduction, smelting and separation at 1450 °C for 1 h to obtain molten iron and a vanadium-titanium-rich slag. The obtained iron sample has a TFe of 99.8 wt. % and an iron recovery rate of 93.09%. The vanadium-titanium-rich slag has a TiO₂ grade above 50 wt. %.

A titanium recovery rate is 94.6 wt. %. A V₂O₅ grade is 1.3 wt. %. A vanadium recovery rate is 84.5 wt. %.

(7) This step is the same as step (7) in Embodiment 1, and a vanadium leaching rate is 85.2%.

An acid digestion rate of the vanadium-leached residue (titanium slag) with 95% concentrated sulfuric acid is 94.2%.

### Embodiment 4

Compared with Embodiment 1, a difference lies only in a modification of steps of (1) to (2). Other operations and parameters are the same as those in Embodiment 1. The modification of steps of (1) to (2) is as follows.

(1) A raw vanadium-titanium magnetite ore is fed into a first-stage crushing operation for crushing and grinding. A fineness of a ground product is controlled such that a content of −0.15 mm fraction is ≥70 wt. %.

(2) The ground product obtained in step (1) is fed into a first-stage TARC for countercurrent tilt gravity separation. A feeding concentration is controlled at 20%. A feeding rate is controlled at 100 L/min. A water flow rate is controlled at 16 L/min. An underflow obtained from the separation is used as a gravity separation rough concentrate of the first-stage TARC. An overflow is used as tailings for direct disposal.

The gravity separation rough concentrate of the first-stage TARC is fed to a second-stage TARC for gravity separation operation. The feeding concentration is controlled at 20%. The feeding rate is controlled at 100 L/min. The water flow rate is controlled at 16 L/min. The underflow obtained from the separation is used as a final iron-vanadium-titanium co-enrichment co-beneficiation concentrate. The overflow obtained from the separation is used as tailings for direct disposal. The tailings obtain by gravity separation of the first-stage TARC and the tailings obtain by gravity separation of the second-stage TARC are combined as the tailings. Indicators of the co-beneficiation concentrate and the tailings obtained according to the above steps are shown in Table 3.

TABLE 3
Implementation results of co-enrichment of iron, titanium,
and vanadium in vanadium-titanium magnetite

| | | TFe | | TiO₂ | | V₂O₅ | |
|---|---|---|---|---|---|---|---|
| Product | Yield/% | Grade/% | Recovery/% | Grade/% | Recovery/% | Grade/% | Recovery/% |
| Co-beneficiation | 58.64 | 50.65 | 78.46 | 15.39 | 82.68 | 0.62 | 83.74 |
| concentrate | | | | | | | |
| Tailings | 41.36 | 18.35 | 21.54 | 4.08 | 17.32 | 0.20 | 16.26 |

The co-beneficiation concentrate is subjected to treatments of steps (3) to (7). Effects are as follows: the molten iron and the vanadium-titanium-rich slag are obtained. A TFe content of the obtained iron sample is 99.6 wt. %. An iron recovery rate is 90%. A TiO₂ grade in the vanadium-titanium-rich slag is above 50 wt. %. A V₂O₅ grade is 1.45%. A titanium recovery rate and a vanadium recovery rate are 98.4% and 90.2%, respectively.

### Embodiment 5

Compared with Embodiment 1, the difference only lies in a modification of steps (4) to (6), specifically as follows.

(4) The iron-vanadium-titanium co-beneficiation concentrate is mixed with a biomass (sawdust), a composite binder (with Mad=8.49%, Ad=28.73%, and Vdaf=60.86%), and magnesite at a mass ratio of 100:6:1:3 to obtain a mixture. The mixture is subjected to pelletizing to form carbon-containing pellets with a diameter of 10 to 14 mm.

(5) The carbon-containing pellets obtained in step (4) are subjected to reduction at a reduction temperature of 1000 °C for 60 min under a H₂ atmosphere to obtain pre-reduced pellets with a metallization degree of 96.56 wt. %, an FeO content of 3.26 wt. %, and an MgO content of 8.42 wt. %.

(6) The pre-reduced pellets obtained in step (5) are subjected to reduction, smelting and separation (with the sawdust amounting to 0.3 wt. % of the pre-reduced pellets) at 1450 °C for 1 h to obtain molten iron and a vanadium-titanium-rich slag. A TFe content of the obtained iron sample is 99.8 wt. %. An iron recovery rate is 92.58%. A TiO₂ grade in the vanadium-titanium-rich slag is above 50 wt. %.

A titanium recovery rate is 95.3 wt. %. A V₂O₅ grade is 1.35 wt. %. A vanadium recovery rate is 86.5 wt. %.

(7) This step is the same as step (7) in Embodiment 1; a vanadium leaching rate is 83.7%.

An acid digestion rate of the vanadium-leached residue (titanium slag) with 95% concentrated sulfuric acid is 95.7%.

### Embodiment 6

Compared with Embodiment 1, the difference only lies in a modification of step (6), specifically as follows.

(6) The pre-reduced pellets obtained in step (5) are subjected to reduction, smelting and separation (with the sawdust amounting to 0.5 wt. % of the pre-reduced pellets) at 1600 °C for 0.5 h to obtain molten iron and a vanadium-titanium-rich slag. A TFe content of the obtained iron sample is 99.4 wt. %. An iron recovery rate is 90.27%. A TiO₂ grade in the vanadium-titanium-rich slag is above 50 wt. %.

A titanium recovery rate is 94.1 wt. %. A V₂O₅ grade is 1.16 wt. %. A vanadium recovery rate is 82.2 wt. %.

(7) This step is the same as step (7) in Embodiment 1; and a vanadium leaching rate is 84.6%.

An acid digestion rate of the vanadium-leached residue (titanium slag) with 95% concentrated sulfuric acid is 95.0%.

### Comparative Embodiment 1

Compared with Embodiment 1, the difference lies only in that a shaking table gravity separation process is used for the gravity separation of step (2), while other operations and parameters are the same as those in Embodiment 1.

After the smelting and separation in step (6), the obtained iron sample has a TFe content of 94.2 wt. %, an iron recovery rate of 80.73%, and a TiO₂ grade in the vanadium-titanium-enriched material is below 40 wt. %, which is unsuitable as a raw material for titanium extraction.

From Embodiment 1 and Comparative Embodiment 1, it can be seen that the countercurrent gravity separation enrichment process of one or more embodiments of the present disclosure helps achieve co-enrichment and co-smelting of ilmenite and vanadium-titanium magnetite in the raw ore, and facilitates selective separation of iron from vanadium-titanium.

### Comparative Embodiment 2

Compared with Embodiment 1, the difference lies only in that, in step (5), the parameters of pre-reduced pellets are adjusted such that the pre-reduced pellets have a metallization degree of 72.56 wt. %, an FeO content of 24.4 wt. %, and an MgO content of 4.75 wt. %.

Through reduction, smelting and separation, molten iron and a vanadium-titanium-rich slag are obtained. The obtained iron sample has a TFe content of 98.5 wt. % and an iron recovery rate of 70%. A TiO₂ grade in the vanadium-titanium-rich slag is below 40 wt. %, making the vanadium-titanium-rich slag unsuitable as a raw material for titanium extraction.

In this embodiment, a metallization degree and parameters such as the FeO content of the pre-reduced pellets are not controlled within a required range, resulting in unsatisfactory selectivity during the subsequent smelting and separation. Therefore, it can also be understood that the pre-reduction process described in one or more embodiments of the present disclosure, in combination with a joint control of pre-reduction conditions, can unexpectedly facilitate successful realization of separation behavior and separation selectivity of iron from vanadium and titanium in a short process of raw ore-co-enrichment-co-smelting.

### Comparative Embodiment 3

Compared with Embodiment 1, the difference lies only in that, in step (4), an equal weight of calcium oxide is used to replace the magnesite. Other operations and parameters are the same as those in Embodiment 1.

Through reduction, smelting and separation, molten iron and a vanadium-titanium-rich slag are obtained. The obtained iron sample has a TFe content of 98.9 wt. %. A slag type of vanadium-titanium-rich slag is not ideal. When subjected to the leaching process of Embodiment 1, a vanadium leaching rate is only 20%.

From Embodiment 1 and Comparative Embodiment 3, it can be seen that failure to control the MgO content in the pre-reduced pellets is detrimental to subsequent separation of iron from vanadium and titanium during smelting and separation. Furthermore, it is also detrimental to regulation of an active vanadium-titanium slag phase.

### Comparative Embodiment 4

Compared with Embodiment 1, the difference lies only in that, in step (4), the amount of the biomass is changed. Experimental groups are as follows.

Group A: a weight ratio of the iron-vanadium-titanium co-beneficiation concentrate to the biomass is 100:15. Other operations and parameters are the same as those in Embodiment 1. In this embodiment, pellets cannot be formed, and subsequent reduction using H₂ cannot be performed.

Group B: the biomass is not added.

The results show that, in step (6), the obtained iron sample has a TFe content of 99.5 wt. % and an iron recovery rate of 80.22%. A TiO₂ grade in the vanadium-titanium-rich slag is 43 wt. %.

A titanium recovery rate is 95 wt. %, and a vanadium recovery rate is 85 wt. %. In step (7), a vanadium leaching rate is 80.5%.

### Comparative Embodiment 5

Compared with Embodiment 1, the difference lies only in that, in step (4), the pre-reduction atmosphere is nitrogen. Other operations and parameters are the same as those in Embodiment 1. A metallization degree of the pre-reduction product is too low (<50%), and the selectivity of smelting and separation is not ideal.

From Embodiment 1, Comparative Embodiment 4, and Comparative Embodiment 5, it can be seen that using a combined process of magnesium oxide-assisted internal carbon charging-gas-solid pre-reduction, co-enrichment and co-smelting behaviors of iron, vanadium, and titanium can be achieved. This process improves the separation selectivity between iron and vanadium-titanium slag, optimizes a phase and physicochemical characteristics of the vanadium-titanium slag, and facilitates the recovery of the vanadium-titanium slag.

### Comparative Embodiment 6

Compared with Embodiment 1, the difference lies only in that the iron-vanadium-titanium co-beneficiation concentrate obtained in step (3) is used to prepare oxidized pellets, which are then pre-reduced. Differing steps are as follows.

(3) The oxidized pellets prepared from the co-beneficiation concentrate obtained in step (2) are pre-reduced to obtain metallized pellets of vanadium-titanium magnetite. Compositions of the oxidized pellets are shown in Table 4.

TABLE 4
Compositions of metallized pellets of vanadium-titanium magnetite (wt. %)

| TFe | FeO | TiO₂ | V₂O₅ | SiO₂ | Al₂O₃ | MgO | CaO | MnO | S | P |
|---|---|---|---|---|---|---|---|---|---|---|
| 57.89 | 3.49 | 9.64 | 0.726 | 2.75 | 3.29 | 2.16 | 0.38 | 0.18 | 0.015 | 0.03 |

(4) Hot metallized pellets, quicklime, and Shanxi Yilin coal are charged into an electric furnace at a mass ratio of 100:8.93:3.8 for deep reduction; after the deep reduction, smelting is performed at 1500 °C for 60 min. The slag and iron are separated to obtain vanadium-bearing molten iron (with an iron recovery rate of approximately 92%) and a titanium-bearing molten separated slag with compositions shown in Table 5 and Table 6, respectively.

TABLE 5
Compositions of vanadium-bearing molten iron (wt. %)

| C | Si | Mn | P | S | V | Ti | Fe |
|---|---|---|---|---|---|---|---|
| 2.2 | 0.51 | 0.11 | 0.02 | 0.02 | 0.58 | 0.14 | Bal |

TABLE 6
Compositions of titanium-bearing molten separated slag (wt. %)

| TiO₂ | SiO₂ | Al₂O₃ | MgO | CaO | FeO | R₂ |
|---|---|---|---|---|---|---|
| 49.4 | 14.1 | 16.9 | 11.1 | 8.2 | 0.4 | 0.58 |

In this comparative embodiment, the titanium-bearing molten separated slag has a TiO₂ content of 49.4 wt %. A large amount of calcium flux is required during the smelting and separation process to lower a melting point of a slag phase. Titanium in the slag mainly exists in a form of perovskite, which is difficult to utilize. Furthermore, vanadium mainly enters the molten iron, and a subsequent vanadium extraction process is the same as a cumbersome vanadium extraction process in blast furnace smelting.

### Embodiment 7

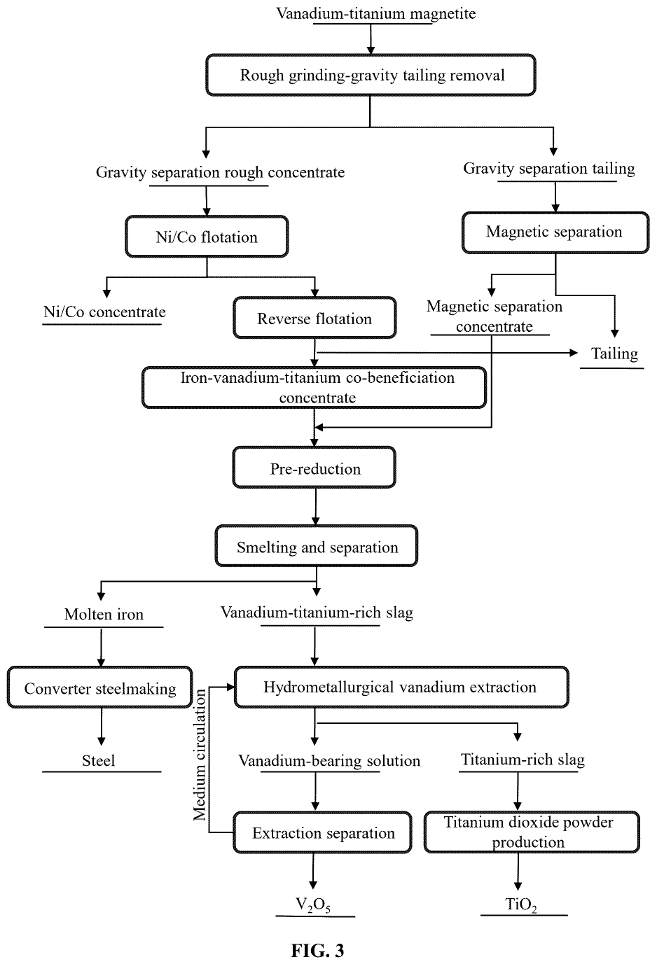

A process is performed as shown in FIG. 3, including following steps.

(1) Following the process of Embodiment 4, a raw ore is subjected to crushing, grinding, and countercurrent gravity separation to obtain a gravity separation concentrate (compositions shown in Table 3) and a gravity separation tailing.

(2) The gravity separation concentrate obtained in step (1) is subjected to Ni/Co sulfide flotation. A flotation pulp concentration is controlled at 40%, with pH=6. A dosage of sulfuric acid for roughing is 600 g/t, a dosage of the sulfuric acid for first scavenging is 200 g/t, and a dosage of the sulfuric acid for second scavenging is 100 g/t. A dosage of butyl xanthate for the roughing is 200 g/t and a dosage of the butyl xanthate for the first scavenging is 80 g/t. The frothe is No. 2 oil. A dosage of the frothe for roughing is 40 g/t and a dosage of the frothe for the first scavenging is 20 g/t. A Ni/Co-containing sulfide concentrate (Ni/Co concentrate) is obtained, which is used for extracting and smelting Ni/Co products.

(3) A flotation tailing obtained in step (2) is subjected to reverse flotation of silicate minerals (including one roughing stage and two scavenging stages as the same as those in Embodiment 1). A dosage of water glass used as a depressant is 800 g/t; a dosage of the depressant for the first scavenging is 500 g/t and a dosage of the depressant for the second scavenging is 300 g/t. A dosage of oleic acid used as a collector is 1000 g/t; a dosage of the collector for the first scavenging is 500 g/t, and a dosage of the collector for the second scavenging is 300 g/t. A dosage of No. 2 oil used as a frother is 80 g/t; a dosage of the frothe for the first scavenging is 40 g/t and a dosage of the frothe for the second scavenging is 20 g/t. An iron-vanadium-titanium co-beneficiation concentrate with a TFe grade exceeding 40 wt. %, a TiO₂ grade exceeding 18 wt. %, and a V₂O₅ content exceeding 0.6 wt. % is obtained from the reverse flotation.

The gravity separation tailing is subjected to magnetic separation to obtain a magnetic separation concentrate. The magnetic separation concentrate and the iron-vanadium-titanium co-beneficiation concentrate from the reverse flotation are mixed to form the iron-vanadium-titanium co-beneficiation concentrate.

(4) The iron-vanadium-titanium co-beneficiation concentrate obtained in step (3) is mixed with a biomass (redwood chips), a composite binder (with Mad=8.49%, Ad=28.73%, and Vdaf=60.86%), and magnesite at a mass ratio of 100:3:1:1.5 to obtain a mixture, and the mixture is then subjected to a pelletizing process to prepare carbon-containing pellets with a diameter of 10-14 mm.

(5) The carbon-containing pellets obtained in step (4) are subjected to reduction in a H₂ atmosphere at a reduction temperature of 1050 °C for 60 minutes to obtain pre-reduced pellets with a metallization degree of 90.53 wt. %, an FeO content of 12.58 wt. %, and an MgO content of 9.82 wt. %.

(6) The pre-reduced pellets obtained in step (5) are mixed with a reductant at a mass ratio of 100:0.5, and are subjected to reduction, smelting and separation at 1450 °C for 1 h to obtain molten iron and a vanadium-titanium-rich slag; steel is obtained using the molten iron for steelmaking in a converter; the vanadium-titanium-rich slag is subjected to hydrometallurgical vanadium extraction to obtain a vanadium-bearing solution and a titanium-rich slag; the vanadium-bearing solution is subjected to extraction separation to obtain V₂O₅, and a titanium dioxide powder production process is performed based on the titanium-rich slag to obtain TiO₂.

The obtained iron sample has a TFe content of 98.4 wt. % and an iron recovery rate of 92.65%. The vanadium-titanium-rich slag has a TiO₂ grade exceeding 40 wt. %.

A titanium recovery rate is 96.8 wt. %. A V₂O₅ grade is 1.2 wt. %, and a vanadium recovery rate was 90.5 wt. %.

(7) This process is the same as step (7) in Embodiment 1; and a vanadium leaching rate is 88.6%.

An acid digestion rate of the vanadium-leached residue (titanium slag) with 95% concentrated sulfuric acid is 96.5%.

This embodiment achieves the simultaneous recovery of elements such as Ni/Co.

One or more embodiments of the present disclosure also include following beneficial effects.

### (1) Process Innovation (Short Process for Co-Enrichment and Co-Smelting of Iron, Vanadium, and Titanium)

### Co-Enrichment:

One or more embodiments of the present disclosure innovate a beneficiation process for iron/titanium separation and an “iron-first, titanium-later” beneficiation process. Through rough grinding, gravity separation, and reverse flotation for silicon-aluminum removal, iron, titanium, and vanadium in the raw ore are synchronously enriched and recovered in inherent mineral phases. The obtained iron-vanadium-titanium co-beneficiation concentrate has a TFe content of 40 to 50 wt. %, a TiO₂ content of 13 to 18 wt. %, and a V₂O₅ content of 0.4 to 1.0 wt. %. The recovery rates of Fe, V, and Ti are significantly improved. This process avoids problem in existing beneficiation where an iron concentrate contains titanium and a titanium concentrate contains iron, both causing losses of Ti and Fe. Moreover, the iron/titanium separation in existing processes requires an extremely fine grinding particle size, which not only increases grinding energy consumption but also makes the subsequent recovery of fine titanium concentrate difficult, resulting in significant losses. In addition, a use of toxic arsenic-based reagents in flotation process increases environmental pressure. Therefore, one or more embodiments of the present disclosure shorten a beneficiation process of the vanadium-titanium magnetite, reduce grinding energy consumption, eliminate usage of toxic reagents, and improve recovery rates of iron, titanium, and vanadium.

### Co-Smelting:

One or more embodiments of the present disclosure also innovate an extraction and smelting process of the vanadium-titanium-iron concentrate. By adopting a short process combining the pre-reduction and the smelting and separation, separation of iron from vanadium-titanium is achieved. Vanadium is enriched in the slag (rather than in the molten iron), thereby simplifying a vanadium extraction process, reducing energy consumption, and improving vanadium recovery. The titanium slag obtained after the hydrometallurgical vanadium extraction can be used as a raw material for the titanium dioxide powder production, greatly enhancing titanium resource utilization.

Based on the short process of co-enrichment and co-smelting, one or more embodiments of the present disclosure effectively reduce process complexity and significantly enhance an overall recovery rate of iron, vanadium, and titanium. For example, the process in one or more embodiments of the present disclosure increases final utilization rates of vanadium and titanium from 44% and 29% in conventional processes to more than 80%.

### (2) High Beneficiation Recovery Efficiency for Co-Enrichment of Iron, Vanadium, and Titanium

The existing vanadium-titanium magnetite beneficiation process is relatively complex, requiring multi-stage grinding and multi-stage separation to obtain an iron concentrate (with an iron grade of 11% to 12%) and a titanium concentrate (with a TiO₂ grade of 45%). During a recovery process, a TiO₂ loss rate is high. One or more embodiments of the present disclosure liberate useful minerals (ilmenite and magnetite) in the vanadium-titanium magnetite from the minerals with relatively coarse disseminated particle sizes (e.g., the feldspar, the olivine, and the pyroxene) through crushing and grinding. The minerals are fed into TARC for gravity separation operation, primarily utilizing the specific gravity differences of mineral particles for separation, thereby achieving co-enrichment of iron, vanadium, and titanium elements. In the countercurrent hydraulic environment with an upward flow opposing gravity, lower-specific-gravity particles (e.g., gangue minerals like feldspar, olivine, pyroxene, and other associates of ilmenite) are entrained into the overflow. Conversely, ilmenite and magnetite particles, possessing sufficient weight to overcome the drag of the upward current, settle downwards, yielding the gravity concentrate. Consequently, the recovery rates of TFe, TiO₂, and V₂O₅ in the iron concentrate obtained from the underflow of gravity separation all exceed 90%, representing a substantial increase in recovery rate compared to conventional gravity separation techniques.

### (3) High Utilization Rate of Titanium and Vanadium Resources Through Pre-Reduction and Smelting-Separation

Traditional blast furnace smelting of the vanadium-titanium iron concentrate requires a TiO₂ content not exceeding 13%, and the obtained titanium slag is of poor quality and difficult to utilize. Furthermore, the vanadium enters the molten iron during the blast furnace smelting, resulting in a complex and inefficient subsequent vanadium extraction process.

One or more embodiments of the present disclosure abandon the traditional blast furnace smelting and propose a short process of the pre-reduction and electric furnace smelting-separation tailored to composition characteristics of the co-beneficiation concentrate. By constructing a new slag system for smelting through an FeO—MgO synergistic regulation in the pre-reduced pellets, selective smelting and separation of iron from vanadium-titanium can be achieved during a smelting and separation stage. Additionally, the phase and the active morphology of the vanadium-titanium slag are optimized, creating conditions for subsequent utilization of titanium in the slag and improving a utilization rate of titanium resources. Simultaneously, the co-enrichment beneficiation regime controls the separation and removal of magnesium-containing minerals from the raw ore, enabling the co-beneficiation concentrate to possess an appropriate MgO content range, which is beneficial for subsequent slag system regulation and slag-iron separation in the smelting process, potentially reducing/avoiding an addition of extra magnesium flux, achieving a beneficial effect of beneficiation-metallurgy. During the smelting process, by controlling a reduction potential and the FeO content in the slag phase, the vanadium is enriched in the slag rather than in the molten iron. Subsequent hydrometallurgical separation and extraction enable an efficient preparation of vanadium products and improve a utilization rate of vanadium resources. A comprehensive recovery rate of iron, vanadium, and titanium in an entire beneficiation-metallurgy process all exceed 70%, representing a significant increase compared to the existing process.

### (4) Reduced Difficulty of Pellet Pre-Reduction

In one or more embodiments of the present disclosure, the iron-vanadium-titanium co-beneficiation concentrate maintains original mineral phases (the ilmenite, the magnetite, and the titanomagnetite) and complex intergrowth relationships of the raw ore, making a reduction of iron ore pellets more difficult than that of conventional iron ore pellets. However, addressing difficulty of the pre-reduction faced by the short process of one or more embodiments of the present disclosure, one or more embodiments of the present disclosure innovatively adopt employ an innovative approach to preparing pre-reduced pellets for electric furnace smelting by integrating the gasification reduction of an internally allocated solid carbonaceous reductant with external gas-based reduction. On one hand, the synergy with external gas-based reduction allows for a decreased dosage of the solid carbonaceous reductant. This effectively avoids issues such as low strength and high tendency for pulverization in carbon-containing pellets. Moreover, as the solid carbonaceous reductant is consumed, it leaves behind numerous pores within the pellet. These pores not only improve the reduction kinetics but also provide space to accommodate the stress induced by reduction expansion, thereby effectively mitigating pellet disintegration caused by such stress. On the other hand, reduction occurs simultaneously both inside and outside the pellet, creating superior kinetic conditions that prevent stress concentration phenomena which would otherwise arise from disparate reduction rates between the core and the surface. The electric furnace smelting-separation in one or more embodiments of the present disclosure requires the pre-reduced pellets to contain a certain amount of FeO, thereby serving to reduce the slag viscosity and improve slag-iron separation conditions. Based on this, a requirement for the metallization degree of the pre-reduced pellets can be appropriately relaxed, and the reduction difficulty of the pellets is greatly reduced. In addition, magnesium-based additives beneficial for the smelting and separation can effectively improve the reduction expansion and reduction degradation performance of vanadium-titanium magnetite pellets during a reduction stage.

### (5) Recovery and Utilization of Ni/Co Rare Elements

In the preferred process of one or more embodiments of the present disclosure, by adding a flotation operation step at a source, Ni/Co sulfide minerals are enriched and recovered. Ni/Co products are produced through the extraction and smelting. If the iron-vanadium-titanium-nickel-cobalt rough concentrate also contains scandium, the scandium can be enriched and recovered together with nickel and cobalt through the described process. The process of one or more embodiments realizes effective recovery and utilization of nickel, cobalt, and other valuable elements without adversely affecting subsequent beneficiation and smelting of iron-vanadium-titanium minerals.

What is claimed is:

1. A method for short-process and high-value utilization of vanadium-titanium magnetite resources, comprising:
(a) subjecting a raw vanadium-titanium magnetite ore to crushing, grinding, and pre-concentration by countercurrent gravity separation; subjecting a gravity separation rough concentrate obtained from the pre-concentration to reverse flotation to remove aluminum- and silicon-bearing minerals to obtain an iron-vanadium-titanium co-beneficiation concentrate enriched with ilmenite and vanadium-titanium magnetite from the raw vanadium-titanium magnetite ore; wherein the raw vanadium-titanium magnetite ore includes the ilmenite, magnetite, and titanium magnetite, and is intergrown with at least one of feldspar, olivine, pyroxene, serpentine, chlorite, and amphibole; wherein a phase in which Fe occurs includes at least one of the magnetite, the ilmenite, fayalite, and pyrite, and a phase in which Ti occurs includes the titanium magnetite and the ilmenite;
wherein a weight ratio of the iron-vanadium-titanium co-beneficiation concentrate, a solid carbonaceous reductant, and a binder is 100:(1~10):(0.5~3);
(b) mixing the iron-vanadium-titanium co-beneficiation concentrate, the solid carbonaceous reductant, the binder, and a magnesium-based modifier to obtain a mixture, and pelletizing or briquetting the mixture to prepare carbon-containing pellets;
subjecting the carbon-containing pellets in a hydrogen-containing atmosphere for a pre-reduction treatment to obtain pre-reduced pellets having a metallization degree of 85 to 98%, an FeO content of 1 to 15%, and an MgO content of 0.5 to 10%; and
(c) smelting and separating the pre-reduced pellets to obtain molten iron and a vanadium-titanium-rich slag.

2. The method according to claim 1, wherein the countercurrent gravity separation is countercurrent tilt gravity separation by a tilted arrowhead revolving chute (TARC); wherein:
during the countercurrent gravity separation, a feeding concentration is 18 to 22%, a feeding rate is controlled at 100 to 150 L/min, and a water flow rate is controlled at 14 to 18 L/min; and
in the iron-vanadium-titanium co-beneficiation concentrate, a TFe content is 40 to 50 wt. %, a TiO₂ content is 13 to 18 wt. %, and a V₂O₅ content is 0.4 to 1.0 wt. %.

3. The method according to claim 1, wherein reagents for the reverse flotation include a reverse flotation depressant and a reverse flotation collector;
the reverse flotation depressant includes one or more of starch, water glass, carboxymethyl cellulose, sodium hexametaphosphate, sodium silicate, and sodium fluosilicate; and
the reverse flotation collector includes one or more of oleic acid, linoleic acid, cetyl quaternary ammonium salt, tetradecyl quaternary ammonium salt, and sodium dimethylaminodecanoate.

4. The method according to claim 1, wherein the iron-vanadium-titanium co-beneficiation concentrate, the solid carbonaceous reductant, the binder, and the magnesium-based modifier are in a mass ratio of 100:3:1:1.5.

5. The method according to claim 1, wherein:
in step (b), the solid carbonaceous reductant includes one or a mixture of anthracite, bituminous coal, lignite, biomass, and biochar; and
the binder includes one or a mixture of a composite binder, modified starch, and cellulose.

6. The method according to claim 5, wherein the solid carbonaceous reductant is the biomass, and the biomass has a fixed carbon content (FCd) of 15 to 20 wt. % and a volatile matter content (Vdaf)≥80 wt. %.

7. The method according to claim 5, wherein the magnesium-based modifier includes at least one of magnesium oxide, hydroxide, carbonate, chloride, nitrate, and organic acid salt.

8. The method according to claim 1, wherein each of the carbon-containing pellets has a diameter of 10 to 20 mm.

9. The method according to claim 1, wherein: during the pre-reduction treatment, a volume fraction of H₂ in the hydrogen-containing atmosphere is greater than or equal to 15%; and
a pre-reduction temperature is 900 to 1200 °C, and a pre-reduction time is 10 to 90 min.

10. The method according to claim 9, wherein the pre-reduction temperature is 950 to 1050 °C, and the pre-reduction time is 30 to 60 min.

11. The method according to claim 1, wherein the metallization degree of the pre-reduced pellets is 90 to 97 wt. %, the FeO content is 1 to 15 wt. %, and the MgO content is 0.5 to 10 wt. %.

12. The method according to claim 11, wherein the FeO content of the pre-reduced pellets is 3 to 10 wt. %, and the MgO content is 2 to 8.5 wt. %.

13. The method according to claim 1, wherein a smelting-separation temperature is 1300 to 1600 °C, and a smelting time is 0.5 to 4 h.

14. The method according to claim 13, wherein the smelting-separation temperature is 1350 to 1450 °C.

15. The method according to claim 1, wherein the vanadium-titanium-rich slag is subjected to crushing and fine grinding, and then is subjected to acid leaching to obtain a vanadium-bearing leach solution and a titanium slag; vanadium is recovered from the vanadium-bearing leach solution, and titanium is recovered from the titanium slag.

16. The method according to claim 15, wherein the vanadium-titanium-rich slag, after crushing and fine grinding, has a particle size controlled such that a content of −0.074 mm fraction is ≥90%;
wherein an acid solution for the acid leaching is hydrochloric acid, an initial hydrochloric acid concentration is 10 to 25%, an acid-to-slag mass ratio is 2:1 to 6:1, a leaching temperature is 30 to 160 °C, and a leaching time is 0.5 to 5 h;
the vanadium is extracted and separated from the vanadium-bearing leach solution, and a vanadium pentoxide product is prepared;
the titanium slag has a TiO₂ grade≥50%; and
the titanium slag is used to prepare titanium dioxide powder.

17. The method according to claim 16, wherein the initial hydrochloric acid concentration is 20%, the acid-to-slag mass ratio is 3:1, the leaching temperature is 60 °C, and the leaching time is 2 h.
